(19) United States
(12) Patent Application Publication
(10) Pub. No.: US 2004/0009105 A1
(43) Pub. Date: Jan. 15, 2004

(54) Converter case and manufacturing method thereof

(76) Inventors: Hiroyuki Watanabe, Toyota City (JP); Hitoshi Horikawa, Toyota City (JP); Motoya Ito, Toyota City (JP)

Correspondence Address: Jeffrey W. Salmon, Welsh & Katz, Ltd., 22nd Floor, 120 S. Riverside Drive, Chicago, IL, 60606, US

(21) Appl. No.: 10/365,044

(22) Filed: Feb. 12, 2003

(30) Foreign Application Priority Data
Feb. 18, 2002 (JP) 2002-039400
Jan. 30, 2003 (JP) 2003-022621

(51) Int. Cl. B01D 53/34

(52) U.S. Cl. 422/179; 422/177; 29/890; 422/180

(57) ABSTRACT

A converter case with prominent reliance/endurance in spite of a smaller number of parts and inexpensiveness. Contents 3 and 4 of a catalyst carrier etc. are received in a multistage state within a converter case 2, which has openings 7 and 8 at both ends of a metallic pipe 6. The converter case 2 is formed of accommodating pipe portions 11 and 12 and a connecting pipe portion 13. The accommodating pipe portions 11 and 12 allow for accommodating the contents 3 and 4. The connecting pipe portion 13 connects the accommodating pipe portions 11 and 12 to one another. A radially reduced part 14 is integrally formed on the connecting pipe portion 13.

### FIELD OF THE INVENTION

The present invention relates to a converter case with openings at both ends of a metallic pipe, in which a plurality of contents which include at least one catalyst carrier can be received in a multistage state, and a manufacturing method.

### BACKGROUND OF THE INVENTION

Usually, catalytic converters which accommodate contents, such as ceramic catalyst carriers and ceramic filters, in a converter case or cases are known well as one for purifying exhaust gas. In recent years, a catalytic converter, whose contents are received in a multistage state within a converter case, is particularly proposed. (e.g., patent documents 1, 3, 4 and 5, particularly refer to document 1, FIG. 1)

Here two conventional examples of converter cases in the catalytic converters are given. Document 3 comprises a deep drawn portion, which is worked to reduce in diameter (radial reduction such as spinning working), being apt to produce remaining stress in the drawn portion after working, the remaining stress tending to cause cracks etc. Document 4 comprises an elbow portion (bent portion) in a housing 5 between receiving portions for monolithic carrier blocks 1, 2. However, formation of such deep drawn portion is difficult in use where its formation is needed based on its disposition.

The converter case 70 shown as an ordinary example in FIG. 7 has two metallic pipes 73 and 74, which accommodate contents (monolithic blocks) 71, 72, and a curved metallic pipe 75 that connects the pipes to each other. This pipe 75 called elbow is shown as if the radially reduced part be formed integrally for attempting to fix the position etc. upon press-fitting the contents. Document 4 does not disclose the working method of the elbow portion, while in case of a conventional converter case shown in Document 5 (refer to FIG. 7), a spacer having a metallic radially reduced part (7a) made up of separate members is welded on a peripheral surface of the pipe (2).

And this radially reduced part limits movement of the contents (catalyst block or pipe body) when the contents are pressed into the pipes from both openings at the manufacturing time. As a result, the contents can easily be fixed on the designated position in the pipe because the position of the contents is fixed. The radially reduced part also prevents the contents from getting out of position in the axial direction caused by vibration of vehicles. Therefore it is supposed that cracks and chips which would result from collision of each other's ends of the contents are also prevented.

A number of conventional devices are shown in the following patents:

[Document 1]: JP-U-1989-111124;

[Document 2]: JP-U-1991-43527;

[Document 3]: JP-U-1991-110120;

[Document 4]: JP-A-1987-19232; and

[Document 5]: JP-A-1994-288232.

The welded joints, however, are given to being uneven with regard to a manufacturing matter of the said conventional converter cases because the means of connecting these members to one another is generally welding, in which, as a result, the quality was also uneven. As for the converter case shown in FIG. 7 cracks are often generated initiating from the radially reduced part because vibration and heat are conducted to the converter case during the use of the catalytic converter. In short, these conventional arts is lack of reliance and endurance.

On the other hand, the conventional converter cases are of a high cost because of a large member of parts, counted as a drawback. For instance, Document 4 shown in FIG. 7, discloses a converter case in which monolithic catalyst blocks are elastically retained within pipe portions 73, 74, respectively, via an elastic fiber material layer (cushion body) 76, 77 (Refer to Documents 1 and 3 with respect to the use of the cushion materials). The entire housing is further surrounded by an outer shell 80 via a cushion material 78.

However, it is difficult to completely prevent the deterioration with lapse of time of the elastic fiber material layers 76, 77 and uneven position or shifting thereof. If positional shifting of the contents made of a fragile ceramic sintered body would occur in an axial direction, the edge parts of the end faces of the contents will abut to the radially reduced part, resulting in fractures or chips at the end edge parts counted as a drawback.

### BRIEF DESCRIPTION OF THE DRAWINGS

FIG. 1 is a front view showing a catalytic converter embodying the present invention.

FIG. 2 is a side view showing a catalytic converter of the present embodiment.

FIG. 3 is an enlarged cross section view showing an important connecting pipe portion in a catalytic converter of the present embodiment.

FIGS. 4(a)-4(c) are summarized cross sectional views in order to illustrate a method for manufacturing a converter case of the present embodiment.

FIG. 5 is an enlarged cross section view showing another important embodiment.

FIG. 6 is an enlarged cross section view showing another important embodiment.

FIG. 7 is a summarized front view showing a catalytic converter in conventional art.

### DETAILED DESCRIPTION OF THE INVENTION

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

It should be further understood that the title of this section of this specification, namely, “Detailed Description Of The Invention”, relates to a requirement of the United States Patent Office, and does not imply, not should be inferred to the limit of the subject matter disclosed herein.

All patents referred to herein, are hereby incorporated herein by reference, whether or not specifically to do so within the text of this disclosure.

In the present disclosure, the words “a” or “an” are to be taken to include both the singular and the plural. Conversely, any reference to plural items shall, where appropriate, include the singular.

In view of the above problems associated with conventional devices, it is a first object of the present invention to provide a converter case, which is prominent in reliance and endurance despite a small number of parts and a low cost.

It is a second object of the present invention to provide a converter case, which is hard to generate cracks and chips on the edge part which are caused by the position shift of the contents.

It is a third object of the present invention to provide a method, in which the prominent converter case can be simply and certainly manufactured.

According to a first aspect of the present invention, there is provided a converter case comprising a metallic pipe, in which the metallic pipe has openings at both ends for receiving a plurality of contents in a multistage state wherein the contents comprising at least one catalyst carrier; wherein a plurality of accommodating pipe portions for accommodating the contents and a connecting pipe portion for connecting the accommodating pipe portions to one another are formed integrally, the connecting pipe portion comprising a bending portion having a radially reduced part with a cross sectional configuration curved or rounded without a sharp corner, and the reduced part being formed integrally in the bending portion through extending the metallic pipe other than the reduced part in a radially expanding direction. (claim 1, basic stracture)

Definition: The term “radially reduced part” herein (may be sometimes called “spool part”) refers to a narrow part in diameter or a part of a reduced radial configuration which extends through the entire circumference along the radial direction of a connecting pipe portion.

Both ends of the converter case is usually connected and fixed to other members, in other words, the converter case is constricted at both ends when the catalytic converter is used mounted on a vehicle. Such a converter case repeats thermal expansion and shrinkage because it is heated by the heat conducting from other members and the heat of exhaust gas. In this case, the thermal stress mainly concentrates on the central part of the case which is not constricted, or the connecting pipe portion, because both ends are constricted. Consequently, the dimensional change is apt to occur in the connecting pipe portion. Moreover, if the connecting pipe portion has the bending portion as stated above, the compressed side in the bending portion is particularly affected by the concentration of the thermal stress because the bending stress is originally inherent in this side. Accordingly, the converter case may crack from the edged corner in the radially reduced part if this part has any sharp edged configuration as the above conventional art. That is, in the case of the conventional art, cracks result because the radially reduced part can almost not absorb the dimensional change of the connecting pipe portion.

According to claim 1 in the first aspect, however, the edged corner, which may be the starting point of cracks, is no more present at the radially reduced part because the radially reduced part has a cross sectional configuration, which is rounded. As a result, the radially reduced part becomes to be hardly affected by the concentration of the thermal stress. In short, the radially reduced part can absorb the dimensional changes in the connecting pipe portion to a certain extent even if the repeated thermal expansion and shrinkage generate these changes. The radially reduced part in the present invention has a good damper effect, with the result that the cracks are hardly generated from the radially reduced part. Therefore, the improvement of the reliance and endurance can be achieved more certainly.

Further, the radially reduced part with the specific cross sectional configuration has no shape edged corner, which would gnaw the edge parts of the contents. Therefore, even if the edge parts would come into contact with the radially reduced part when the contents get out of position in the axial direction, cracks and chips of the edge parts caused by gnawing are certainly prevented.

According to the feature of claim 2, the contents comprise a catalyst carrier(s) or filter(s) made of sintered ceramic, a mat like seal material of ceramic is disposed around an outer peripheral part of the contents, and the reduced part having a minimum diameter shorter than a diameter of the contents.

According to the feature of claim 2, there is interposed an elastic or flexible mat like seal material between the converter case and the catalyst carrier or filter, which absorbs the vibration to certain extent. Thus, the loosening would hardly occur in the catalyst carrier, resulting in effective prevention of release or fall down of the catalyst carrier etc.

Even if the catalyst carrier etc. would fall down, the end edge parts of the catalyst carrier etc. will inevitably abut to the radially reduced part, which further prevent the catalyst carrier etc. from falling down further. Therefore, a catalyst carrier etc. positioned upward (or upstream) of the radially reduced part can be prevented from colliding with a catalyst carrier etc. disposed below (or downstream) the radially reduced part so as to stably prevent formation of fractures and chips in the end face,

The sealing capacity is prone to be deteriorated by wind erosion because a mat like seal made of a ceramic material is directly exposed to exhaust gas of high temperature (e.g. 900° C.) for a long time. According to the present invention, however, the mat like seal at the lower position of the radially reduced part is hidden behind the radially reduced part. In short, the exhaust gas of high temperature is easy to blow against the radially reduced part functioning a windbreak, but hard to blow against the said mat like seal behind the radially reduced part. Accordingly, the sealing capacity is prevented from getting worse because the wind erosion of the mat like seal caused by the exhaust gas of high temperature is prevented.

According to a second aspect of the present invention, there is provided a method of manufacturing a converter case, in which the converter case comprises a metallic pipe, the metallic pipe has openings at both ends for receiving a plurality of contents in a multistage state, the contents comprising at least one catalyst carrier; comprising forming a bending portion through bending the metallic pipe at a position to be formed in the connecting pipe portion, and molding a radially reduced part comprising a cross sectional configuration curved or rounded without a sharp corner at the position through extending the metallic pipe other than the reduced part in a radially expanding direction working fluid pressure; wherein a plurality of accommodating pipe portions for accommodating the contents and a connecting pipe portion for connecting the accommodating pipe portions to one another are formed integrally.

If the metallic pipe is simply bent at the position at which the connecting pipe portion is (to be) formed, a compressed side in a bent position of the connecting pipe portion is wrinkled caused by concentration on the bending stress. If such wrinkles are made, the converter case is prone to crack from the wrinkles when the thermal expansion and shrinkage are repeated. If the radially reduced part, however, is formed by extending the metallic pipe other than the radially reduced part to radially expand at the position at which the connecting pipe portion will constitute the radially reduced part after working (termed “connecting pipe forming portion”), relying on fluid pressure, the metallic material at the “connecting pipe forming portion” is drawn out.

Therefore the above two steps stated as herein-above mentioned allow smoothing out the wrinkles in the compressed side of the bent portion and forming the radially reduced part with a good cross sectional configuration (yet more, with an essentially reduced residual stress caused by the radially reducing working). Accordingly, it is possible to manufacture the above good converter case simply and certainly.

According to the feature of claim 4, there is provided a method of manufacturing the converter case. The method comprises a first step of bending the metallic pipe at a position at which the connecting pipe portion is to be formed, and a second step of forming the radially reduced part at the position, at which the connecting pipe portion is formed, through applying fluid pressure on the inner peripheral surface of the metallic pipe.

According to the feature of claim 4, the step of forming the radially reduced part smoothes out the wrinkles even if the step of bending the metallic pipe would produce the wrinkles in the compressed side of the bent part. This method of the present invention that the step of forming the radially reduced part follows the step of bending the metallic pipe can efficiently manufacture the radially reduced part with a good configuration as compared with the method that the step of bending the metallic pipe follows the step of forming the radially reduced part. Further, expensive manufacturing equipment is necessary if the step of bending the metallic pipe is simultaneous with the step of forming the radially reduced part. The present invention, however, can reduce costs of the converter case because the expensive equipment is not necessary. According to further features of the other dependent claims, temperature (heat) can be exerted together with the fluid pressure by applying a heated fluid, or by heating a part of a die which functions for radial reduction (actually serving to maintain the inherent configuration of the pipe), whereupon the radially reducing working is conducted. This will further reduce the residual stress generated in the radially reduced part after the radial reducing.

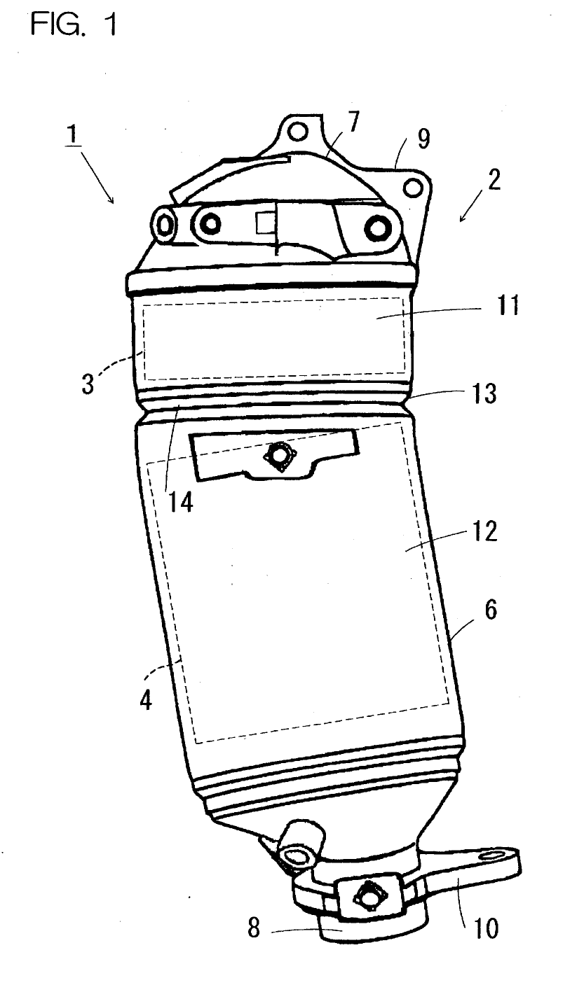

A catalytic converter for purifying exhaust gas, which is an embodiment of the present invention, is explained in detail with reference to FIGS. 1 to 4 as follows.

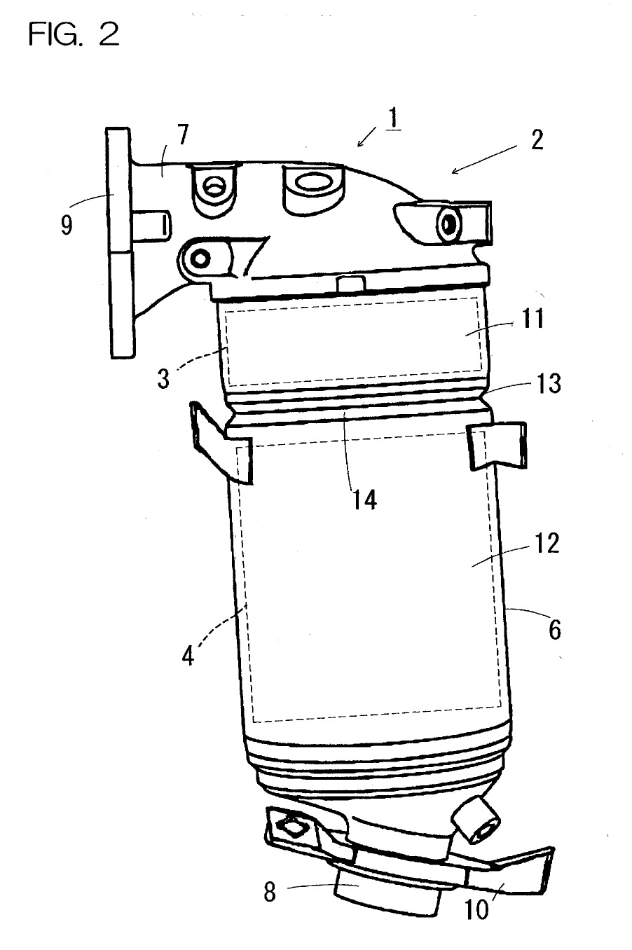

As shown in FIGS. 1 and 2, a catalytic converter 1 of the present embodiment comprises a converter case 2 and catalyst carriers 3 and 4, etc.

This converter case 2 comprises a heat-resistant metallic pipe 6, the metal being presented by stainless steel etc. The metallic pipe 6, whose cross sectional configuration is round, has opening parts 7 and 8 at both ends. As shown in FIGS. 1 and 2, an upper (upstream) flange 9 is formed on the outer periphery of the upper (upstream) opening part 7. A lower (downstream) flange 10 is formed on the outer periphery of the lower (downstream) opening part 8. The upper flange 9 is rigidly fixed on the exhaust manifold side of an engine, which is not illustrated, with bolts and nuts. On the other hand, the lower flange 10 is rigidly fixed on the front pipe side composing the exhaust pipe, which is not illustrated, in the same way. In short, this catalytic converter 1 is directly attached to an engine. In attaching directly, the metallic pipe 6 is disposed to extend along the vertical direction. Exhaust gas ejected form an engine flows to the catalytic converter 1 from the upper opening part 7, passes through the inside and flows out of the lower opening part 8 when the engine is driven in the condition of being fixed on the case.

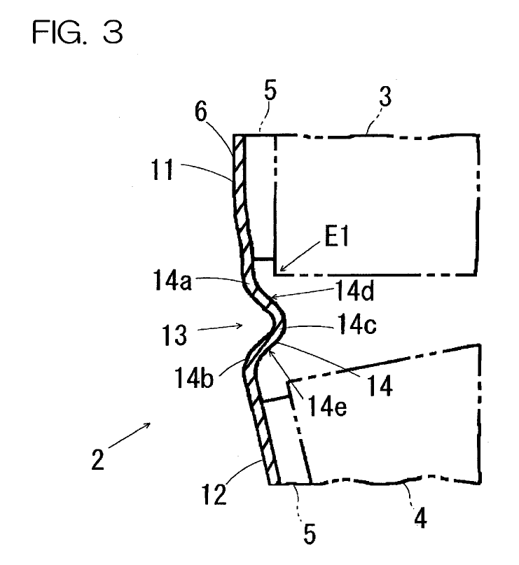

This metallic pipe 6 has two accommodating (receiving) pipe portions 11, 12 and one connecting pipe portion 13. The accommodating pipe portions 11, 12 and the connecting pipe portion are integrally formed without any step of joining, such welding etc. The catalytic carrier 3 like a disk, of which the mat like seal 5 is wound around the outer peripheral part, is pressed into the inside of the first part of accommodating pipe portion 11 as shown in FIG. 3. The catalytic carrier 4 like a column, of which a seal material like a mat 5 is wound around the outer peripheral part, is pressed into the inside of the second part of accommodating pipe portion 12. In short, the catalytic carriers 3 and 4 in the catalytic converter 1 of the present embodiment are received in a multistage state (that is, in upper and lower stages) inside of the metallic pipe 6.

The mat like seal 5 is composed by materials of heat-resistant ceramics, such as alumina fibers etc. The catalytic carriers 3 and 4 of the present embodiment are made of porous ceramics of a sintered body, which is represented by Cordierite etc. The surface of the sintered body has a catalyst of noble metals etc. in order to purify the exhaust gas. Honeycomb structure, which has a lot of cells piercing through the carriers along the axis, is available as this kind of catalytic carriers. Then the honeycomb structure is allowed to seal the openings of each cell alternately (that is, a honeycomb filter).

The two accommodating pipe portions 11 and 12 are connected by the connecting pipe portion 13. The converter case 2 assumes the form of bending slightly like an obtuse angle because the connecting pipe portion 13 of the present embodiment is bent or crooked to some extent. The main reason why such a bending portion is provided at the connecting pipe portion 13 is as follows. In short, it is hard to make sure of a space to load the catalytic converter and to load it freely because an engine room is very congested in recent years. Accordingly, if there is only a bent space in the engine room, the converter case 2 itself should be synchronized with that space.

The radially reduced part 14, which is extended over the entire girth of the metallic pipe 6, is integrally formed at the bent portion of the connecting pipe portion 13 as shown in FIG. 3 etc. This radially reduced part 14 has the first curving section 14a and the second curving section 14b, which form concave toward the inside of the pipe, and the third curving section 14c, which forms a convex(peak) toward the inside of the pipe. The third curving section 14c is located between the first curving section 14a and the second curving section 14b. These curving sections 14a-14c have a dull angle but not an acute angle. Accordingly, the radially reduced part 14 shown in FIG. 3 has a cross sectional configuration curved or rounded without a sharp, edged corner as a whole.

An area, which connects the first curving section 14a and the third curving section 14c, is a slope of the upstream side 14d. The slope of the upstream side 14d tilts to the downstream end side of the catalyst carrier 3 by 30 to 60 degrees and faces the edge part of the end side E1. An area, which connects the second curving section 14b and the third curving section 14c, is a slope of the downstream side 14e. The slope of the downstream side 14e also tilts to the upstream end of the catalyst carrier 4 by 30 to 60 degrees.

The minimum diameter of the radially reduced part 14, that is to say, the inside diameter of the third curving section 14c is set somewhat shorter than the diameter of the catalyst carriers 3 and 4.

An example of a method for manufacturing the said converter case 2 is introduced.

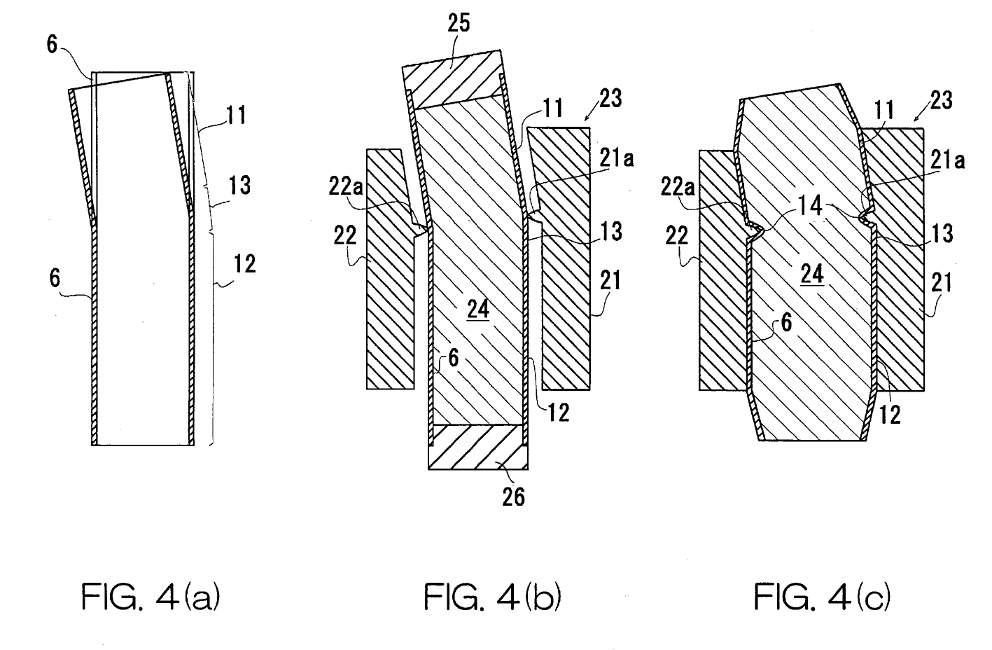

It is necessary to prepare a straight metallic pipe 6 when a converter case 2 of the present embodiment is going to be manufactured. The metallic pipe 6 is bent at the position, where the connecting pipe portion 13 should be formed later, by a press process without an illustration (cf. FIG. 4(a)). The compressed side (the right side in FIG. 1) in the connecting pipe portion 13 may be wrinkled according to the kind of material or the condition of a bending step at the time immediately following such a bending step of the metallic pipe.

The following is a step of forming the radially reduced part 14 at a position, where the connecting pipe portion 13 has been formed, by means of a action of a fluid pressure on the inner peripheral surface of the metallic pipe 6.

In this case, a bulge forming (hydroforming) is performed by an apparatus to form pipes shown in FIG. 4(b). The apparatus has a metallic die assembly 23 for press, which comprises a first die 21 and the second die 22 and is divided into two parts. Projecting ribs 21a and 22a like an arc are provided on the forming surfaces of the first die 21 and the second die 22 corresponding to the position of the part of the connecting pipe 13. The metallic pipe 6 is set up between the first die 21 and the second die 22. Then, the metallic pipe 6 is charged with water 24 as a fluid. And seals 25 and 26 are placed at both ends of the metallic pipe 6 in order to seal up the pipe. The first die 21 and the second die 22 are closed under the condition that water pressure is applied. And the radially reduced part 14 is formed at a targeted position of the metallic pipe 6. Application of water pressure may be performed by either pushing the seals 25 and 26 into the metallic pipe 6, or injecting water into the metallic pipe 6 through the seals 25 and 26, and so on.

The shape of the metallic pipe 6 is changed in accordance with the forming surface because water pressure on the whole inner peripheral surface of the metallic pipe 6 stretches and expands out the metallic material to extend (enlarge) the diameter (cf. FIG. 4(c)). The wrinkles are smoothed out looking at the radially reduced part 14 because said part of the metallic material is stretched out to radially extend the pipe material. Further, it is possible to adopt a forming manner to reduce the only place of the radially reduced part 14 and not to extend the other place instead of the forming manner to extend the whole metallic pipe 6 as stated above. The liquid pressure may be generally applied through a suitable pressure medium as hydraulic or fluid pressure, preferably a medium that can be heated to a desired temperature.

Then, after opening the first die 21 and the second die 22, the metallic pipe 6 is taken out. Finally it is possible to get the converter case 2 having a desired shape after the other parts are processed as the need arises.

Accordingly, it is possible to get the following results based on the present embodiment.

In the converter case 2 of the present embodiment, the metallic material other than the radially reduced part is worked for expansion in the radially expanding direction (i.e., bulge-worked), by which the residual stress is essentially reduced at the radially reduced part 14. Further, the two accommodating pipe portions 11 and 12, for accommodating the catalyst carriers 3 and 4, and the connecting pipe portion 13, which connects these parts, are integrally formed. Also, the radially reduced part 14 is integrally formed on the connecting pipe portion 13. Accordingly, the number of the parts certainly decreases in comparison with the number of parts in the conventional converter cases, which comprises separate members for assembly. Therefore, the converter case 2 is easily manufactured because the step of connecting these members to one another is unnecessary. And, there is, in principle, no need to concern with generation of unevenness at the welded joints, generation of thermal strain caused by the welding and deterioration of the mechanical strength and of the seal at the welded joints (seams) because it is unnecessary to weld these members to one another. Therefore, it is possible to gain even quality as compared with the quality of conventional manner based on welding and to achieve a prominent reliance and endurance.

(2) In this converter case 2, the radially reduced part 14, whose cross sectional configuration is curved or rounded without a sharp edged corner, is integrally formed at the bent portion of the connecting part 13. Accordingly, the edged corner, which may be a starting point of cracks, is eliminated at the radially reduced part 14 because the radially reduced part 14 has the rounded cross sectional configuration. As a result, the radially reduced part 14 comes to be hardly affected by the concentration of the thermal stress. In short, the radially reduced part 14 can absorb the dimensional changes in the connecting pipe portion 13 to a certain extent even if the repeated thermal expansion and shrinkage generate these changes. In such a present embodiment, the radially reduced part 14 has a good damper effect, with the result that the cracks are hardly generated from the radially reduced part 14. Therefore, the improvement of the reliance and endurance can be achieved.

(3) Further, the radially reduced part 14 with the cross sectional configuration has no edged corner, which gnaws the edge part E1 of the catalyst carriers 3 and 4. Therefore, even if the edge part E1 comes into contact with the radially reduced part 14 when the upper (upstream) catalyst carrier 3 gets out of position in the falling direction, cracks and chips of the edge part E1 caused by gnawing are certainly prevented. This allows the catalyst carrier 3 to prolong the service life and the catalytic converter 1 to maintain the function for a long time.

(4) In the present embodiment, the mat like seal 5 made of ceramic material is wound around the outer peripheral part of the catalyst carrier 3 and 4 made of sintered ceramic. The minimum diameter in the radially reduced part 14 is set shorter than a diameter of the catalyst carriers 3 and 4. In short, the vibration is absorbed to a certain extent by the mat like seal 5 because the elastic seal 5 lies between the converter case 2 and the catalyst carriers 3 and 4. Therefore, this particular upper catalyst carrier 3 can be effectively prevented from falling away because the catalyst carriers 3 and 4 are hardly loosened. If the catalyst carrier 3 should fall, the edge part E1 of the catalyst carrier 3 inevitably comes into contact with the radially reduced part 14 because the minimum diameter in the radially reduced part 14 is shorter than the diameter of the catalyst carrier 3. This contact certainly prevents the catalyst carrier 3 from falling further. Accordingly, cracks and chips of the edge part, which might be generated by the collision between the upper catalyst carrier 3 and the lower catalyst carrier 4 in the radially reduced part 14, are also certainly prevented. Therefore, it is more certainly possible to prolong the life of the catalyst carrier 3 and to maintain the function of catalytic converter 1 for a long time.

(5) In this converter case 2, the mat like seal 5 in the lower position of the radially reduced part 14 is hidden in the rear of the radially reduced part 14. In short, exhaust gas of high temperature is easy to blow against the radially reduced part 14 functioning as a windbreak, but hard to blow against the mat like seal 5 in the rear of the radially reduced part 14. Accordingly, the sealing capacity is prevented from getting worse because wind erosion of the mat like seal 5 caused by the exhaust gas of high temperature is prevented. The effect that the mat like seal 5 prevents the catalyst carrier 4 from loosening is also maintained.

(6) The method of manufacturing the converter case 2 in the present embodiment comprises the first step of bending the metallic pipe and the second step of forming the radially reduced part by means of working of the fluid pressure as stated above. Accordingly, the step of forming the radially reduced part smoothes out the wrinkles even if the step of bending the metallic pipe produces the wrinkles in the compressed side of the bent part. This method also allows manufacturing the radially reduced part 14 with a good outline more efficiently as compared with a method, which comprises the first step of forming the radially reduced part and the subsequent second step of bending the metallic pipe. Then, an expensive manufacturing equipment is necessary if the step of bending the metallic pipe is simultaneous with the step of forming the radially reduced part. The present invention, however, can reduce the costs of the converter case 2 because the expensive equipment is not necessary. In short, the method of the present embodiment can easily and certainly manufacture the converter case 2, whose reliance, endurance, etc. is prominent.

Furthermore, the embodiments of the present invention are allowed to be modified as follows.

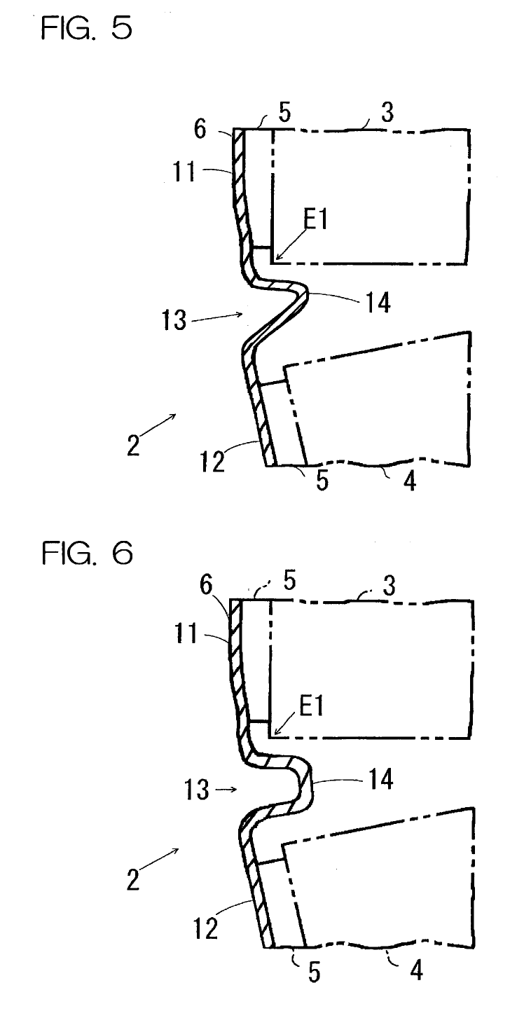

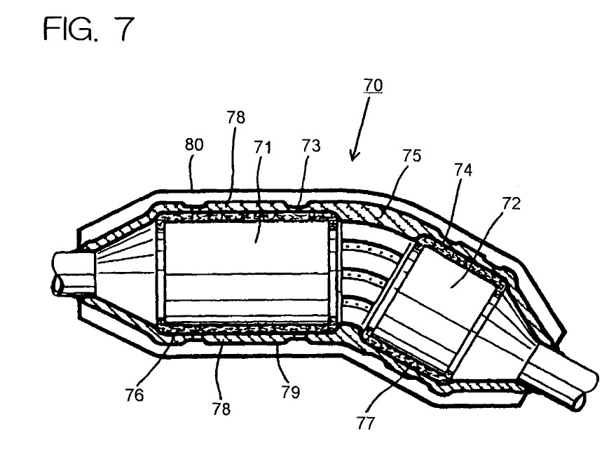

The cross sectional configuration of the radially reduced part 14 is not limited to the above embodiment and allowed to change into another configuration, such as in FIG. 5 and FIG. 6. The configuration of the bending portion in FIG. 5 is somewhat more angular instead of the third curving section 14c. The cross sectional configuration of the radially reduced part 14 in FIG. 6, which is angularly U-shaped, is different from the configuration of the above embodiment, which is gently V-shaped. But the cross sectional configuration of the above embodiment is more desirable in respect of relatively less concentration of stress and better damper effect.

The converter case 2 in the present invention is allowed to be embodied as a type of directly attaching to an engine, a type of setting on a floor, such that the converter case 2 is horizontally disposed on a position some separated from an engine, or a type that the catalytic converter is integral with a manifold.

The metallic pipe can be directly mounted on an engine, and disposed the metallic pipe about vertically (termed as “direct mount type”).

In case of the converter case which is directly mounted to an engine, an end on the upstream side is rigidly fixed to the engine side. An end on the downstream side is also rigidly fixed to a front pipe side constituting an exhaust pipe. Therefore, both ends of such a converter case are fixed under a very tight constriction state. Accordingly, the connecting pipe portion is more largely affected by thermal stress when the converter case is directly mounted to an engine than when the case is attached somewhat separately. In this case large thermal stress is generated in the converter case because the case is exposed to the exhaust gas of high temperature ejected directly from an engine. In short, if the converter case is directly attached to an engine, the problem, which is the generation of cracks in the spool part and the deterioration of the reliance and endurance by the cracks, is conspicuous all the more.

Moreover, the contents would become more easily to shake because the vibration of an engine is directly conducted to the converter case which is attached directly than not directly. The contents in an upper position, in particular, are easy to fall because of shakiness of the contents in case of the above mentioned arrangement. Therefore, granted that the radially reduced part be equipped, an act of the gravity would make a shock to the spool part larger. And granted that the spool part with a sharp corner is equipped, the problem, i.e., of cracks and chips of the edge parts caused by gnawing, is conspicuous all the more.

In that respect, the improvement in the reliance and endurance of the converter case, which is used in harsh conditions, and the prevention of cracks and chips in the edge part are achieved because the feature of the direct mount type can solve the above problem.

The contents are allowed to be the catalyst carriers 3 and 4 shown in the embodiment or a mere filter without the catalyst. The contents are allowed to be received not only in two stages but also in three stages or over.

Both cross sectional configurations of the first accommodating pipe portion 11 and the second accommodating pipe portion 12 in the present embodiment are a circle with the same diameter. But the embodiment is not limited to such a configuration. For instance, a diameter of the second accommodating pipe portion 12 is allowed to be longer than a diameter of the first accommodating pipe portion 11 (change of diameter). The cross sectional configuration of the second accommodating pipe portion 12 is also allowed to be an ellipse or other non-circles (change of cross sectional configuration). By the way, it is desirable to make a change of diameters and a change of cross sectional configurations at a time in the step of forming the radially reduced part by the bulge forming.

Then, technical ideas grasped from the above embodiments etc., except for technical ideas as stated in the claims, are enumerated as follows.

A method for manufacturing the converter case (particularly of those mentioned in claim 1 or 2), which comprises the first step of bending the metallic pipe at a position at which the connecting pipe portion is formed and the second step of forming the radially reduced part at a position at which the connecting pipe portion is formed and of making change of diameters/cross sectional configuration of the accommodating pipe portion by means of action of a fluid pressure on the inner peripheral surface of the metallic pipe. Therefore, according to the present invention, it is efficiently possible to get a comparatively inexpensive converter case with a complicated shape by a comparatively easy method because the working of the fluid pressure can form the radially reduced part and make a change of the diameters/cross sectional configuration at the same time. The term “change of the cross sectional configuration” refers to make into a different cross sectional shape, (i.e., form a uniform circle into, e.g., a polygon).

A catalyst converter with a converter case and a ceramic catalyst carrier/filter: the converter case, whose several accommodating pipe portions are integrally formed with a connecting pipe portion for connecting the accommodating pipe portions to one another and, a mat like seal made of a ceramic material is wound around the outer peripheral part of the said catalyst carrier/filter. Accordingly, it is possible to provide a catalyst converter with an efficient seal and a long life because the present invention prevent the chips/cracks caused by falling away of the catalyst carrier/filter from generating.

The effect of the present invention is summarized as follows.

According to claim 1 as described above in detail, it is possible to provide the converter case with prominent reliance and endurance based on the effective suppression of crack formation starting from the radially reduced pipe, in spite of the smaller number of the parts and the inexpensiveness. Also, fracture and chips at the end edge portions of the contents caused by gnawing by the radially reduced pipe can be prevented with sure. Therefore, the long life of the contents and the maintenance of the catalytic converter function for a prolonged period of time can be achieved.

According to claim 2, it is possible not only effectively to prevent the catalyst carriers etc. from falling away but also certainly to prevent the cracks/chips of the catalyst carriers caused by the collision of one another if they should fall away. Furthermore, it is possible to prevent the mat like seal from eroding away.

According to claim 3, it is possible to provide a manufacturing method with an improved reliance/endurance of the converter case with a simple and reliable manner.

According to claim 4, it is possible not only to improve a rate of a quality product but also to reduce the costs of manufacturing the converter case because it is possible to efficiently manufacture the converter case with an excellent shape.

Also it should be noted that any combination of the disclosed and/or claimed elements, matters and/or items may fall under the modifications aforementioned.

It should be noted that other objects, features and aspects of the present invention will become apparent in the entire disclosure and that modifications may be done without departing the gist and scope of the present invention as disclosed herein and claimed as appended herewith.

Also it should be noted that any combination of the disclosed and/or claimed elements, matters and/or items may fall under the modifications aforementioned.

What is claimed is:

1. A converter case comprising a metallic pipe, in which
said metallic pipe has openings at both ends for receiving a plurality of contents in a multistage state wherein said contents comprising at least one catalyst carrier; wherein
a plurality of accommodating pipe portions for accommodating said contents and a connecting pipe portion for connecting said accommodating pipe portions to one another are formed integrally,
said connecting pipe portion comprising a bending portion having a radially reduced part with a cross sectional configuration curved or rounded without a sharp corner, and
said reduced part being formed integrally in said bending portion through extending said metallic pipe other than said reduced part in a radially expanding direction.

2. The converter case as defined in claim 1, wherein
said contents comprise a catalyst carrier(s) or filter(s) made of sintered ceramic,
a mat like seal material of ceramic is disposed around an outer peripheral part of said contents, and
said reduced part having a minimum diameter shorter than a diameter of said contents.

3. A method for manufacturing a converter case, in which
said converter case comprises a metallic pipe,
said metallic pipe has openings at both ends for receiving a plurality of contents in a multistage state, said contents comprising at least one catalyst carrier; comprising
forming a bending portion through bending said metallic pipe at a position to be formed in a connecting pipe portion, and
molding a radially reduced part comprising a cross sectional configuration curved or rounded without a sharp corner at said position through extending said metallic pipe other than said reduced part in a radially expanding direction working fluid pressure;
wherein a plurality of accommodating pipe portions for accommodating said contents and said connecting pipe portion for connecting said accommodating pipe portions to one another are formed integrally.

4. The method for manufacturing a converter case as defined in claim 3, wherein
bending said metallic pipe at a position for forming said connecting pipe portion, prior to a step of molding said reduced part at said position for forming said connecting pipe portion through applying a working fluid pressure on an inner surface of said metallic pipe.

5. The method for manufacturing a converter case as defined in claim 3, wherein
said working fluid pressure is applied via a heating fluid.

6. The method for manufacturing a converter case as defined in claim 3, wherein
said molding step is carried out under a state that at least a part of a mold working on said reduced part for radial reduction is heated.

7. The method for manufacturing a converter case as defined in claim 3, wherein said molding step comprises;
changing cross sectional configuration of said accommodating pipe portion on both sides of said reduced part into a different one from a circular configuration.

8. The method for manufacturing a converter case as defined in claim 3, wherein said molding step comprises;
providing said accommodating pipe portion with a radially varied configuration on both sides of said reduced part.
